(19) United States
(12) Patent Application Publication
(10) Pub. No.: US 2018/0374280 A1
(43) Pub. Date: Dec. 27, 2018

(54) Vehicular Remote-Data Transceiver

(71) Applicant: The Government of the United States, as represented by the Secretary of the Army, Washington, DC (US)

(72) Inventors: Karl LaSala, Rising Sun, MD (US); John Suarez, Brooklyn, NY (US)

(21) Appl. No.: 15/631,024

(22) Filed: Jun. 23, 2017

(51) Int. Cl. G07B 15/06; G06Q 20/34; G06Q 20/32

(52) U.S. Cl. CPC G07B 15/063; G06Q 20/24; G06Q 20/325; G06Q 20/34

(57) ABSTRACT

Various embodiments are described that relate to a transceiver, such as a transceiver associated with a vehicle. The transceiver can receive information from a user, such as by way of the user inserting a credit card or an identification card into a card reader of the transceiver. Based on this received information, the transceiver can output a signal. This signal can be used to communicate various details, such as financial transaction information or information to allow access to an area.

### GOVERNMENT INTEREST

The innovation described herein may be manufactured, used, imported, sold, and licensed by or for the Government of the United States of America without the payment of any royalty thereon or therefor.

### BACKGROUND

A person or group of people can travel in a vehicle. In one example, the vehicle can travel on a highway system. To maintain the highway system, tolls can be assessed to the vehicle, such as by a state government. One manner of obtaining these tolls is to have the driver stop, pay a toll with cash, and then the vehicle continues on its journey. Stopping on the highway system can be inefficient on multiple fronts, from the stopping of traffic flow to higher emission from the vehicle coming to a stop.

### SUMMARY

In one embodiment, a vehicle transceiver comprises a reception component and a transmission component, both that are at least partially hardware. The reception component can be configured to receive a personal identification information set that pertains to a user by way of reading a card of the user. The transmission component can be configured to wirelessly transmit a signal derived, at least in part, from the personal identification information that pertains to the user.

In another embodiment, a system comprises a card reader to obtain a personal identification information set associated with a specific user. The system can additionally comprise a signal generator to generate a signal based, at least in part, on the personal identification information set associated with the specific user. The system can also comprise an antenna to cause a transmission of the signal. In addition, the system can comprise a housing to retain the card reader, the signal generator, the antenna, where the transmission of the signal occurs while the housing is in motion.

In a further embodiment, a method can be performed by a transceiver associated with a vehicle. The method can comprise collecting a personal information set for a first user occupying the vehicle. The method can also comprise collecting a personal information set for a second user occupying the vehicle. Additionally, the method can comprise transmitting a signal that communicates the personal information set for the first user and that communicates the personal information set for the second user.

### BRIEF DESCRIPTION OF THE DRAWINGS

Incorporated herein are drawings that constitute a part of the specification and illustrate embodiments of the detailed description. The detailed description will now be described further with reference to the accompanying drawings as follows:

FIG. 1 illustrates one embodiment of a system, such as a transceiver, comprising a reception component and a transmission component;

FIG. 2 illustrates one embodiment of a system comprising a processor and a computer-readable medium;

FIG. 3 illustrates one embodiment of an example transceiver;

FIG. 4 illustrates one embodiment of an example transceiver and card environment;

FIG. 5 illustrates one embodiment of a vehicle with a transceiver passing through a gate to a gated area;

FIG. 6 illustrates one embodiment of a method that can be performed by the transceiver;

FIG. 7 illustrates one embodiment of a method comprising four actions;

FIG. 8 illustrates one embodiment of a method comprising five actions; and

FIG. 9 illustrates one embodiment of a method comprising four actions.

### DETAILED DESCRIPTION

A more efficient way to have the vehicle pay the toll is for the vehicle to be equipped with a transceiver. In one example, the transceiver can have a transponder number. When a toll stop is passed, the transponder number can be transmitted to a gate device. The gate device can associate the transponder number with a financial account and deduct an amount of money from the account equal to a toll of the toll stop. While this can work with a single occupant scenario, such as a single person driving or a family traveling together, this may not work for other scenarios.

One scenario that may benefit from an improvement is when there are multiple occupants in a vehicle. Another scenario that may benefit from an improvement is when the driver is less tied to the transceiver and/or the transceiver is less tied to a transaction location. With these, a more customizable transceiver experience can be employed.

The following includes definitions of selected terms employed herein. The definitions include various examples. The examples are not intended to be limiting.

“One embodiment”, “an embodiment”, “one example”, “an example”, and so on, indicate that the embodiment(s) or example(s) can include a particular feature, structure, characteristic, property, or element, but that not every embodiment or example necessarily includes that particular feature, structure, characteristic, property, or element. Furthermore, repeated use of the phrase “in one embodiment” may or may not refer to the same embodiment.

“Computer-readable medium”, as used herein, refers to a medium that stores signals, instructions and/or data. Examples of a computer-readable medium include, but are not limited to, non-volatile media and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, other optical medium, a Random Access Memory (RAM), a Read-Only Memory (ROM), a memory chip or card, a memory stick, and other media from which a computer, a processor or other electronic device can read. In one embodiment, the computer-readable medium is a non-transitory computer-readable medium.

“Component”, as used herein, includes but is not limited to hardware, firmware, software stored on a computer-readable medium or in execution on a machine, and/or combinations of each to perform a function(s) or an action(s), and/or to cause a function or action from another component, method, and/or system. Component may include a software controlled microprocessor, a discrete component, an analog circuit, a digital circuit, a programmed logic device, a memory device containing instructions, and so on. Where multiple components are described, it may be possible to incorporate the multiple components into one physical component or conversely, where a single component is described, it may be possible to distribute that single component between multiple components.

“Software”, as used herein, includes but is not limited to, one or more executable instructions stored on a computer-readable medium that cause a computer, processor, or other electronic device to perform functions, actions and/or behave in a desired manner. The instructions may be embodied in various forms including routines, algorithms, modules, methods, threads, and/or programs, including separate applications or code from dynamically linked libraries.

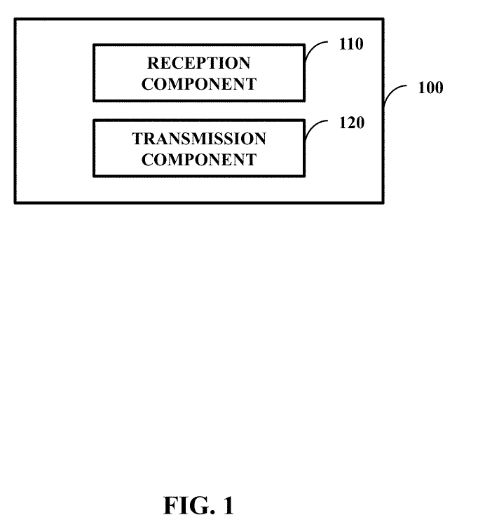

FIG. 1 illustrates one embodiment of a system 100, such as a transceiver (e.g., vehicle transceiver), comprising a reception component 110 and a transmission component 120. The reception component 110 can be configured to receive a personal identification information set that pertains to a user by way of reading a card of the user. The transmission component 120 can be configured to wirelessly transmit a signal (e.g., that communicates data) derived, at least in part, from the personal identification information that pertains to the user.

In one embodiment, the personal identification information set comprises a financial transaction information set and the signal indicates the financial transaction information set. The financial transaction information set can include a credit card or debit card account number. In one example, the user can place their credit card next to the transceiver upon starting their vehicle. The reception component 110 can read the credit card to determine the credit card number. The credit card number can be encrypted and the transmission component 120 can transmit the credit card number to an approved location. An approved location can be toll booths that are designated by the user (e.g., toll booths in Delaware or government-based toll booths while toll booths on private roads are excluded). The reception component 110 can receive a confirmation from a particular toll booth that successfully processes the signal.

In one embodiment, the transceiver can function with an interface component (e.g., that is part of the reception component 110). The interface component can be configured to cause a graphical user interface (GUI) to be presented on a display associated with a vehicle operatively coupled with the vehicle transceiver. An example of the display can be an automobile dashboard interface or a cell phone synchronized with the vehicle (e.g., mounted on the vehicle dashboard and communicating by way of Bluetooth). The reception component 110 can be configured to receive an interface presentment information set. The interface component can employ the interface presentment information set to cause the GUI to be presented. In one embodiment, the user inputs an interface input information set by way of the GUI. The signal can indicate at least part of the interface input information set. The interface input information set can be the personal identification information set or be separate from the personal identification information set. As an example of when they are separate, the interface input information can be ordering information for a good (e.g., coffee) or service (e.g., car wash) and the financial transaction information set can be account information (e.g., credit card number) to pay for the good or service.

In one example, the user can be a driver of an automobile functioning as a vehicle. The driver can visit the drive-through of his or her favorite fast food restaurant. Instead of speaking to a person through an intercom and placing an order, the transceiver can cause the GUI to be presented. For example, the reception component 110 can receive information from the fast food restaurant and the interface component can produce a GUI from the information from the fast food restaurant. The driver can place his or her order through the GUI, the interface component can process the order to produce the signal that indicates the order as part of order information, and the transmission component 120 can transmit the signal. Additionally, the GUI can facilitate payment, such as the driver typing credit card information into the GUI as part of the order information.

The GUI, and transceiver in general, can be implemented with various features. One example feature can be communication from a restaurant and/or an interactive experience. This can be sending coupons with the interface presentment information (e.g., generic coupons, coupons tailored for the driver, or coupons based on ordering practice such as a discount to order a large drink when the driver selects a medium drink), linkage information to link the GUI with an account of the user (e.g., rewards program information stored on a mobile device of the driver), or others. Another example feature can be the ability of multiple users to pay for an order. As an illustration of this example, the driver can have a single passenger. The driver can pay for his or her order while the single passenger can pay for his or her order. Multiple credit cards can be entered by way of the GUI or processed through the GUI. As an example of processing through the GUI, the driver and single passenger can place their credit cards next to the transceiver such that the transceiver reads the information useful in the transaction. By way of the GUI, the driver and single passenger can select which portion of the order is assigned to the different accounts and this information can be transmitted by way of the signal by the transmission component 120.

As an example of a service, the same driver can be driving the automobile and stop for gasoline. The gasoline station can be full-service and therefore a service (although this can be considered both a good (the gasoline) and a service (the person pumping so the driver does not exit his or her vehicle). The gasoline can be pumped from the station tank to the vehicle and once complete and/or as gasoline is transferred, the transceiver can run a transaction to pay for the gasoline.

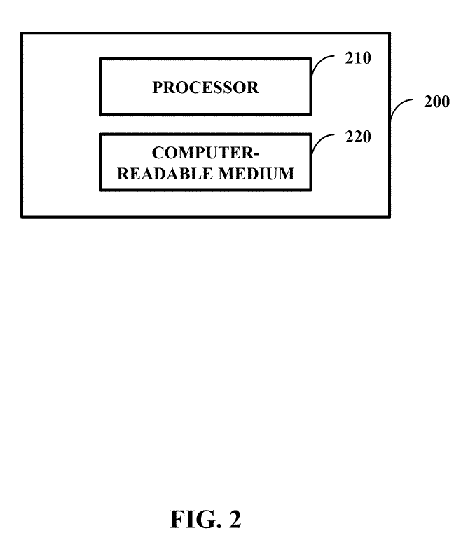

FIG. 2 illustrates one embodiment of a system 200 comprising a processor 210 (e.g., a general purpose processor or a processor specifically designed for performing a functionality disclosed herein) and a computer-readable medium 220 (e.g., non-transitory computer-readable medium). In one embodiment, the computer-readable medium 220 is communicatively coupled to the processor 210 and stores a command set executable by the processor 210 to facilitate operation of at least one component disclosed herein (e.g., the reception component 110 of FIG. 1). In one embodiment, at least one component disclosed herein can be implemented, at least in part, by way of non-software, such as implemented as hardware by way of the system 200 (e.g., an encryption component that encrypts the signal before the transmission). In one embodiment, the computer-readable medium 220 is configured to store processor-executable instructions that when executed by the processor 210, cause the processor 210 to perform a method, that can be an example algorithm, disclosed herein (e.g., the methods 600-900 addressed below).

In one embodiment, the computer-readable medium 220 is configured to retain the personal identification information set after reception (e.g., after being read from a credit card) and can retain instructions for a timer component and a determination component (and therefore the processor 210 and the computer-readable medium 220 are the timer and determination components). The timer component can be configured to track a time of how long the computer-readable medium 220 retains the personal identification information set. The determination component can be configured to make a determination on if the time meets a threshold (e.g., surpasses the threshold, does not surpass the threshold, equals or surpasses the threshold, or equals or does not surpass the threshold). When the time meets the threshold, then the personal identification information set is forcibly deleted from the computer-readable medium 220. When the time does not meet the threshold, then the personal identification information set is not forcibly deleted from the computer-readable medium 220.

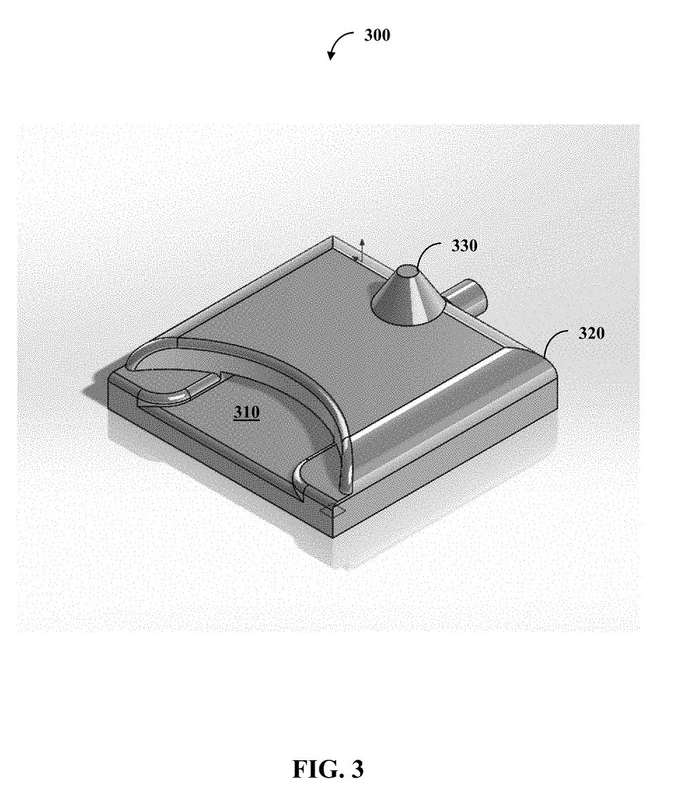

FIG. 3 illustrates one embodiment of an example transceiver 300. The transceiver 300 can include a card reader 310. The card reader 310 can read a card (e.g., credit card, smart card with an embedded microchip, etc.) associated with the user. The card reader 310 can function in various embodiments, such as the card being inserted into the card reader 310 or the card being held near the card reader 310 (e.g., physically against the card reader 310.) The card reader 310 can function as a collection component that can obtain a personal identification information set associated with a specific user.

In addition, the transceiver 300 can include a housing 320 that retains the system 200 of FIG. 2 and the computer-readable medium 220 of FIG. 2 can be used to retain the personal identification information set associated with the specific user. The housing 320 can retain a signal generator (e.g., implemented by way of the processor 210 of FIG. 2 and/or the computer readable medium 220 of FIG. 2). The processor 210 of FIG. 2 can process instructions retained by the computer-readable medium 220 of FIG. 2 so that the processor 210 of FIG. 2 functions as a generation component that can generate a signal based, at least in part, on the personal identification information set associated with the specific user.

The transceiver 300 can also include an antenna 330 that can cause a transmission of the signal and therefore operate as an output component. The antenna 330 can work with a transmitter of the system 200 of FIG. 2 (e.g., a radio frequency transmitter that employs the antenna 330 or an optical transmitter).

The housing 320 can also retain the antenna 330 as well as the card reader 310. While disclosed as discrete, different hardware can work collectively as components, such as the antenna 330 and the system 200 of FIG. 2 working together to cause the transmission. Further, before transmission by the antenna 330, the system 200 of FIG. 2 can process the signal. In one example, the signal can be encrypted. This encryption can include generation of an encrypted signal (e.g., encryption and generation occur as one process) or encryption following generation (e.g., after the signal is generated, the signal is subjected to an encryption algorithm). For example, the personal identification information set can comprise a financial transaction information set. The signal can indicate the financial transaction information set (e.g., credit card information) and communicate the financial transaction information set in an encrypted manner.

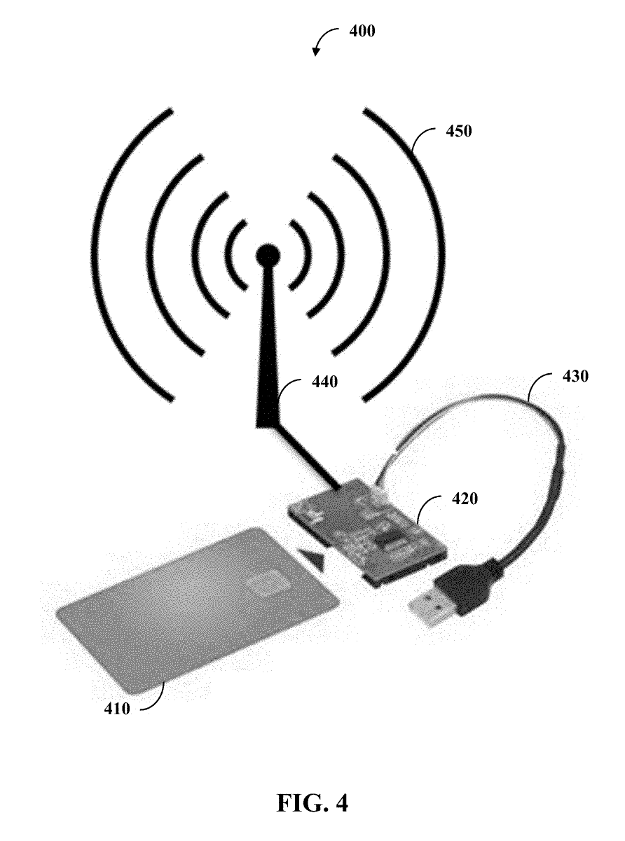

FIG. 4 illustrates one embodiment of an example transceiver and card environment 400. A card 410 can be inserted into hardware 420 (e.g., hardware that comprises the system 200 of FIG. 2). The hardware 420 can be powered in various manners, such as by being self-powered (e.g., by way of a battery) or being powered externally by way of a plug 430. In one example, the vehicle can be an automobile (e.g., self-driving automobile) and the plug 430 can connect with a USB (Universal Serial Bus) port of the vehicle. Other example vehicles can include a motorcycle, a boat, an airplane, a helicopter, or a bicycle. The vehicle can include an antenna 440 that emits the signal 450, such as according to Radio Frequency protocol.

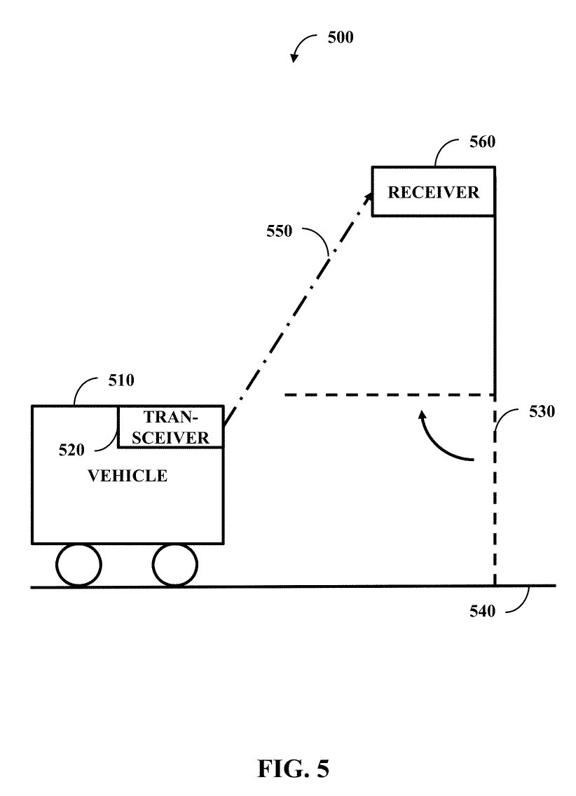

FIG. 5 illustrates one embodiment of a vehicle 510 with a transceiver 520 (e.g., the system 100 of FIG. 1) passing through a gate 530 to a gated area 540. The transceiver 520 can obtain the personal identification information by way of a Common Access Card (CAC). The personal identification information can comprise security verification information. Based on this information, a signal 550 can be derived and transmitted to a receiver 560. The transceiver 520 can transmit the signal 550 while the vehicle 510 is in motion. The signal 550 can be received by a receiver 560 that controls the gate 530. The signal can be configured to cause the gate 530 of the gated area 540 to open such that the gate 530 does not prevent the vehicle from entering the gated area 540.

The information can be processed in different manners by the transceiver 520 and the receiver 560. Consider an example of an employee traveling to their job on a bicycle where their office parking lot requires presentment of a CAC. The employee can insert the CAC into the transceiver 520 and the transceiver 520 can process information obtained from the CAC insertion. In one embodiment, the transceiver 520 can authenticate the CAC information and then send a signal to the receiver 560 that the CAC information is authenticated. In one embodiment, the transceiver 520 can send the raw CAC and the receiver 560 can authenticate the CAC information. After authentication, the gate 530 can open. In one embodiment, periodically (e.g., randomly) the gate can be determined to not open and a guard can do a spot check of the CAC. Other verification can occur, such as facial recognition techniques by the receiver 560 to verify the person whose CAC is presented and/or a biometric device (e.g., thumbprint scanner) of the transceiver 520 to determine that the person's CAC aligns with the person in the vehicle 510. As an example of further authentication, a failsafe can be used, such as if the person uses their right thumb they are authenticated, but if the person uses their left thumb a distress is communicated to the receiver 560. Gaining biometric information can be done before a user starts the vehicle 510 (e.g., entering biometric information is not allowed while the vehicle 510 is on to facilitate safe travel), be retained for a certain amount of time, or be activated when the vehicle is within a set physical distance from the gate 530.

The gate 530 can protect different gated areas 540. Example gated areas can include military instillations, nuclear power plants, oil refineries, banks, and technology companies. Further, different transceivers can be issued and the receiver 560 can distinguish between different transceivers. In one example, an oil refinery can have two areas with security—a general parking area for general employees and a delivery parking area where ships dock and supply crude oil (e.g., the delivery parking area is a parking area for dock workers). A first class of transmitter can allow access to both the general parking area and the delivery parking area while the second class of transmitter can allow access to the general parking area, but not the delivery parking area (e.g., allow access with the proper card being inputted—when the card is removed the transmitter 520 does not function). Since security where ships come in and/or where crude oil is delivered can be considered more important to have heightened security, the different classes of workers can be defined or different vehicles can be defined (e.g., a personal transceiver that is for personal vehicles and gives access just to the general parking area and a work transceiver for work trucks and gives access just to the delivery parking area). In one embodiment, as opposed to issuing two different kinds of transmitters, one kind of transmitter can be issued, but with two different kinds of access cards (e.g., the same physical access card with different credentials depending on access allowed to a user or vehicle).

In one embodiment, the vehicle 510 can transport multiple occupants. There can be a first user (e.g., driver) and second user (e.g., passenger) in the vehicle 510. The transceiver 520 can be configured to receive a personal identification information set that pertains to the first user and the second user. In one example, the first user and second user can sequentially submit the CACs to the transceiver 520 and the transceiver 520 can retain the CAC information. The signal can be derived, at least in part, from first user's CAC information and the second user's CAC information.

While being discussed with regard to the vehicle 510, aspects disclosed herein can be practiced in other areas. In one example, the transceiver 520 can be employed by a restaurant. The transceiver 520 can allow multiple users to enter multiple credit cards and split a check (e.g., evenly or allocating items individually). In another example, a mobile device, such as a smart phone, can function as the transceiver 520 and/or the supplier of the personal identification information set. Further, multiple suppliers of the personal identification information set can be used. In one example, the first user can provide a credit card while the second user can provide a mobile device. The credit card and mobile device can communicate the information to the receiver 520.

In another non-vehicle example, the transceiver 520 can be employed by a runner. The transceiver can be a cellular telephone worn on the arm of the runner by way of an armband. The runner can encounter a toll bridge and the cellular telephone can be employed to pay the a of the bridge quickly so the runner does not stop his/her run.

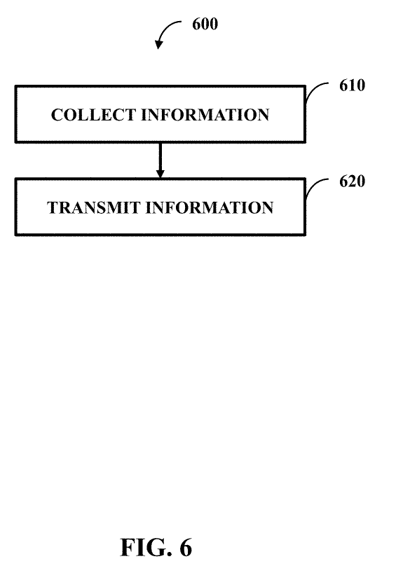

FIG. 6 illustrates one embodiment of a method 600 that can be performed by the transceiver 520 of FIG. 5. At 610, collection of a personal information set for a first user occupying a vehicle (e.g., the vehicle 510 of FIG. 5) and a personal information set for a second user occupying the vehicle can take place. At 620, there can be transmitting a signal (e.g., the signal 550 of FIG. 5) that communicates the personal information set for the first user and that communicates the personal information set for the second user.

Returning to the environment of FIG. 5, the personal information sets can be security authentication information sets for entry into the gated area 540 that is a secured area. The secured area can be controlled by a base station (e.g., the receiver 560 of FIG. 5). The signal can be transmitted to the base station.

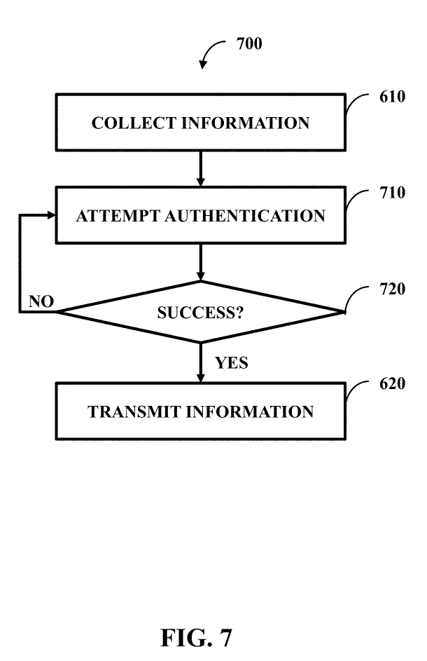

FIG. 7 illustrates one embodiment of a method 700 comprising four actions 610-620 and 710-720. At 610, the information can be collected. At 710 and 720, authenticating of the security authentication information sets can take place. This can include attempting authentication at 710 and determining if the attempt is successful at 720. If authentication is not successful, then the method can return to 710—after a certain number of attempts the method can end (e.g., a failure message can be displayed on a display of the transceiver, such as a red light flashing as opposed to a green light with successful communication). If the authentication is successful, then the information can be transmitted by way of the signal from the transceiver to the base station. The signal can communicate successful authentication information for the first and second security authentication information sets. The base station can process the successful authentication information for the first and second security authentication information sets to allow access of the vehicle to the secured area. With this, the transceiver 520 of FIG. 5 can communicate post-authentication security information.

In one embodiment, the signal does not indicate an authentication of the first security authentication information set and the second security authentication information set. With this, authentication can occur at the base station and the signal communicates unauthenticated information. The base station can attempt authentication of the first and second security authentication information sets. When the base station successfully authenticates the first and/or the second security information set (e.g., authentication of both is required or just one is required), the base station causes the vehicle to be able to access the secured area. When the base station unsuccessfully authenticates the second security information set (e.g., just the second security information set or along with unsuccessful authentication of the first security information set), the base station can cause the vehicle to be denied access to the secured area. While authentication is discussed at the transceiver or at the base station, in one embodiment, authentication occurs at the transceiver and the base station for extra security.

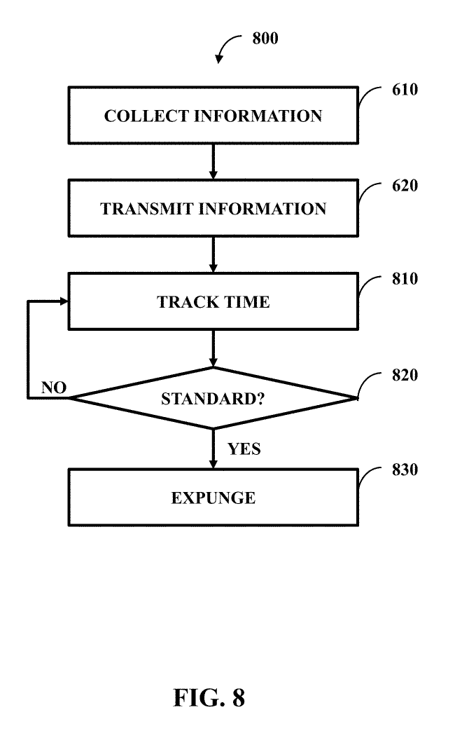

FIG. 8 illustrates one embodiment of a method 800 comprising five actions 610-620 and 810-830. At 610, information can be collected and at 620, the information can be transmitted. At 810, there can be tracking a period of how long after collection of at least one of the personal information set of the first user, the personal information set of the second user, or a combination thereof. For example, the time can be from when a first-in-time information set is collected or a more recent-in-time information set is collected. At 820, checking if the period meets a standard can take place. When the period does not meet the standard, then the personal identification information set is expunged from the transceiver 830. When the period meets the standard, then the personal identification information set is not expunged from the transceiver and the time can continue to be tracked at 810.

In one example, the first user information set can be a first credit card information set for the first user and the second user information set can be a second credit card information set for the second user. Therefore, both are financial account information sets. The transceiver can be a mobile device, such as a mobile device of the first user. The second user may not want his or her credit card information stored on the first user's mobile device for a long term. Therefore, the mobile device can hold the second user's information for a limited amount of time (e.g., preset in the phone or set by the second user). The transceiver can be outfitted with various buttons, such as an auxiliary button to allow for switching between users (e.g., indicating when a second user card is being entered and when the first user information should be kept) and/or a delete button that deletes user information even if a set time has not expired.

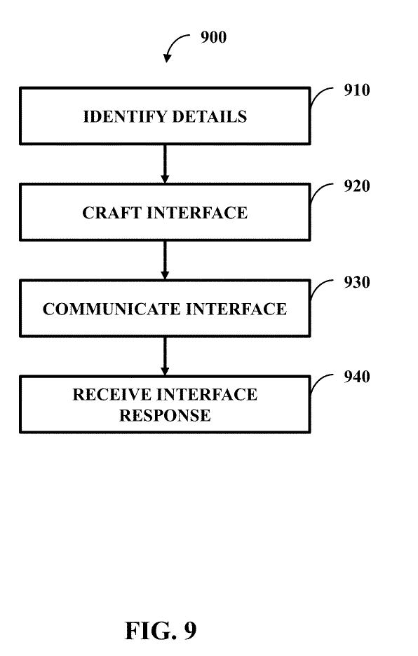

FIG. 9 illustrates one embodiment of a method 900 comprising four actions 910-940. This can be a method of how a base station functions with the transceiver. The method 900 can be employed by a fast food restaurant when interacting with a user. That example is used in describing an example implementation of this method.

At 910, details can be identified. These details can be received from the transceiver 520 of FIG. 5. The details can include user identification information, such as account number.

These details can be used to craft an interface at 920. The interface can be generic or be customized to the user. In one example, a rewards account for the user can be accessed to see ordering history. Based on this ordering history, a specific coupon and/or advertisement can be selected for the user and made part of the interface such that when the vehicle displays the interface, the specific coupon and/or advertisement can be presented.

At 930, the interface can be communicated to a transceiver. In one example, the interface is generic and is communicated to multiple vehicles. This communication can be direct (e.g., to ‘vehicle A’ and ‘vehicle B’) or indirect (e.g., any vehicle within x feet of the base station, with x being an integer and being determined based on base station sensitivity and/or transmission power). At 940, the base station (or a different entity from what sends out the interface) can receive a response to the interface and can process the response. In one example, the response can be a food order and the base station can charge an account of the user and send an order for the food to be prepared.

The base station can make other determinations. In one example, the base station can determine if a vehicle is friendly or not in a military context (e.g., a vehicle without a transceiver that can be successfully authenticated is classified as a foe until determined otherwise). Further, a military force can have multiple bases in multiple states. A transceiver can be issued to a soldier stationed at a base in Maryland, where the base issues the transceiver. When the soldier travels to the issuing base, then the soldier can have ay likelihood of being randomly stopped when presenting a transceiver with an authorized CAC. When the soldier travels to another base, then the soldier can have an x likelihood, with x being greater than y and x and y being a positive number.

Various benefits can be derived from practicing aspects disclosed herein. There can be shorter lines at gates and less personnel, leading to possible cheaper operations or diversion of personnel. As an example, if gates are manned by police officers, then using less officers to check identifications can lead to having more officers available for other policing tasks.

While the methods disclosed herein are shown and described as a series of blocks, it is to be appreciated by one of ordinary skill in the art that the methods are not restricted by the order of the blocks, as some blocks can take place in different orders. Similarly, a block can operate concurrently with at least one other block.

What is claimed is:

1. A vehicle transceiver, comprising:
a reception component, that is at least partially hardware, configured to receive a personal identification information set that pertains to a user by way of reading a card of the user; and
a transmission component, that is at least partially hardware, configured to wirelessly transmit a signal derived, at least in part, from the personal identification information that pertains to the user.

2. The vehicle transceiver of claim 1,
where the personal identification information set comprises a financial transaction information set and
where the signal indicates the financial transaction information set.

3. The vehicle transceiver of claim 2, comprising:
an interface component configured to cause a graphical user interface to be presented on a display associated with a vehicle operatively coupled with the vehicle transceiver,
where the reception component is configured to receive an interface presentment information set,
where the interface component employs the interface presentment information set to cause the graphical user interface to be presented,
where the user inputs an interface input information set by way of the graphical user interface, and
where the signal indicates at least part of the interface input information set.

4. The vehicle transceiver of claim 3,
where the interface input information set comprises ordering information for a service and
where the financial transaction information set is account information to pay for the service.

5. The vehicle transceiver of claim 3,
where the interface input information set comprises ordering information for a good and
where the financial transaction information set is account information to pay for the good.

6. The vehicle transceiver of claim 1,
where the vehicle transmitter is associated with a vehicle,
where the personal identification information set comprises security verification information,
where the transmission component is configured to transmit the signal while the vehicle is in motion, and
where the signal is configured to cause a gate of a gated area to open such that the gate does not prevent the vehicle from entering the gated area.

7. The vehicle transceiver of claim 1, comprising:
a non-transitory computer-readable medium configured to retain the personal identification information set after reception;
a timer component configured to track a time of how long the non-transitory computer-readable medium retains the personal identification information set; and
a determination component configured to make a determination on if the time meets a threshold,
where when the time meets the threshold, then the personal identification information set is forcibly deleted from the non-transitory computer-readable medium and
where when the time does not meet the threshold, then the personal identification information set is not forcibly deleted from the non-transitory computer-readable medium.

8. The vehicle transceiver of claim 1,
where the user is a first user,
where the vehicle transmitter is associated with a vehicle,
where the reception component is configured to receive a personal identification information set that pertains to a second user,
where the first user and the second user are occupants of the vehicle, and
where the signal is derived, at least in part, from the personal identification information set that pertains to the first user and from the personal identification information set that pertains to the second user.

9. A system, comprising:
a card reader to obtain a personal identification information set associated with a specific user;
a signal generator to generate a signal based, at least in part, on the personal identification information set associated with the specific user;
an antenna to cause a transmission of the signal; and
a housing to retain the card reader, the signal generator, the antenna,
where the transmission of the signal occurs while the housing is in motion.

10. The system of claim 9, comprising:
an encryption component to encrypt the signal before the transmission,
where the housing is to retain the encryption component,
where the housing is operatively coupled with a motorized vehicle,
where the personal identification information set comprises a financial transaction information set,
where the signal indicates the financial transaction information set, and
where the transmission of the signal occurs while the motorized vehicle is in motion.

11. The system of claim 9, comprising:
a housing that retains the card reader, the signal generator, and the antenna,
where the housing is operatively coupled to a motorized vehicle,
where the personal identification information set comprises a security entry authorization information set,
where the signal communicates that the motorized vehicle is authorized enter a secured area, and
where the transmission of the signal occurs while the motorized vehicle is in motion.

12. The system of claim 9,
where the personal identification information set associated with the specific user is a first personal identification information set associated with a first user,
where the card reader is to obtain a second personal identification information set associated with a second user,
where the signal generator is to generate the signal based, at least in part, on the first personal identification information set associated with the first user and the second personal identification information set associated with the second user.

13. A method, performed by a transceiver associated with a vehicle, comprising:
collecting a personal information set for a first user occupying the vehicle;
collecting a personal information set for a second user occupying the vehicle; and
transmitting a signal that communicates the personal information set for the first user and that communicates the personal information set for the second user.

14. The method of claim 13,
where the personal information set for the first user is a first security authentication information set to indicate authorization to enter a secured area,
where the personal information set for the second user is a second security authentication information set to indicate authorization to enter the secured area, and
where the signal is transmitted to a base station.

15. The method of claim 14,
where the signal does not indicate an authentication of the first security authentication information set and the second security authentication information set,
where the base station attempts authentication of the first security authentication information set and the second security authentication information set, and
where the base station causes the vehicle to be able to access the secured area when the base station successfully authenticates the first security information set and when the base station successfully authenticates the second security information set.

16. The method of claim 15,
where the base station causes the vehicle to be able to access the secured area when the base station successfully authenticates the first security information set and when the base station unsuccessfully authenticates the second security information set.

17. The method of claim 15,
where the base station causes the vehicle to be denied access the secured area when the base station successfully authenticates the first security information set and when the base station unsuccessfully authenticates the second security information set.

18. The method of claim 14, comprising:
authenticating, by the transceiver, of the first security authentication information set; and
authenticating, by the transceiver, of the second security authentication information set,
where the signal communicates successful authentication information for the first security authentication information set,
where the signal communicates successful authentication information for the second security authentication information set, and
where the base station processes the successful authentication information for the first and the second security authentication information sets to allow access of the vehicle to the secured area.

19. The method of claim 14, comprising:
tracking a period of how long after collection of at least one of the personal information set for the first user, the personal information set for the second user, or a combination thereof; and
checking if the period meets a standard,
where when the period does not meet the standard, then the collected personal identification information set is expunged from the transceiver and
where when the period meets the standard, then the collected personal identification information set is not expunged from the transceiver.

20. The method of claim 13,
where the personal information set for the first user is a financial account information set associated with the first user and
where the personal information set for the second user is a financial account information set associated with the second user.
